(19) United States
(12) Patent Application Publication
(10) Pub. No.: US 2025/0142692 A1
(43) Pub. Date: May 1, 2025

(54) OPERATING METHOD FOR AN ELECTRIC ARC FURNACE

(71) Applicant: Primetals Technologies Germany GmbH, Erlangen (DE)

(72) Inventor: Thomas MATSCHULLAT, Eckental (DE)

(21) Appl. No.: 18/834,948

(22) PCT Filed: Dec. 21, 2022
(86) PCT No.: PCT/EP2022/087190

§ 371 Date: Jul. 31, 2024

(30) Foreign Application Priority Data
Feb. 7, 2022 (EP) 22155430.6

(51) Int. Cl. H05B 7/148; F27B 3/28; F27D 19/00

(52) U.S. Cl. CPC H05B 7/148; F27B 3/28; F27D 19/00; F27D 2019/0037

(57) ABSTRACT

Based on desired values (X*) of electrical energy that is to be supplied to the electrodes, the control device of the electric arc furnace determines provisional voltage setpoint values (U1*). If voltages (U) corresponding to the provisional voltage setpoint values (U1*) are applied to the electrodes, first actual values (X) of electrical energy supplied to the electrodes would be approximated as closely as possible to the desired values (X*). The control device actuates an energy supply device of the electric arc furnace based on definitive voltage setpoint values (U2*). Voltages (U) corresponding to the definitive voltage setpoint values (U2*) are applied to the electrodes. At least during the initial melting phase, the control device determines the definitive voltage setpoint values (U2*) by limiting the provisional voltage setpoint values (U1*) to an admissible maximum value (Umax).

### TECHNICAL FIELD

The present invention is based on an operating method for an electric arc furnace, wherein metal in a furnace vessel of the electric arc furnace is melted during a melting phase, wherein a control device of the electric arc furnace
determines preliminary target voltage values on the basis of target electrical variables of electrical energy to be supplied to the electrodes, with the result that, when voltages corresponding to the preliminary target voltage values are applied to the electrodes, first actual electrical variables of electrical energy supplied to the electrodes are approximated as far as possible to the target electrical variables, and
controls an energy supply device of the electric arc furnace on the basis of definitive target voltage values, with the result that voltages corresponding to the definitive target voltage values are applied to the electrodes, with the result that the energy supply device draws electrical energy from a supply network and supplies it to the electrodes via a furnace transformer.

The present invention is furthermore based on a control program for a control device of an electric arc furnace, wherein the control program comprises machine code which can be executed by the control device, wherein the execution of the machine code by the control device has the effect that the control device operates the electric arc furnace in accordance with an operating method of this type.

The present invention is furthermore based on a control device of an electric arc furnace, wherein the control device is programmed with a control program of this type, such that the control device operates the electric arc furnace in accordance with an operating method of this type.

The present invention is furthermore based on an electric arc furnace,
wherein the electric arc furnace has a furnace vessel, to which metal can be supplied,
wherein the electric arc furnace has an energy supply device and electrodes as well as a furnace transformer,
wherein the energy supply device is connected, on the input side, to a supply network and is connected, on the output side, to the electrodes via the furnace transformer,
wherein the electric arc furnace has a control device which can control the energy supply device,
wherein the control device is designed as explained above.

### PRIOR ART

The subjects mentioned are generally known. For example, reference may be made to WO 2015/176 899 A1. EP 1 026 921 A1 and EP 3 124 903 A1 may also be mentioned in this context.

### SUMMARY OF THE INVENTION

When melting metal—vin particular steel—in an electric arc furnace, the electrical energy is supplied to the electrodes of the electric arc furnace via a furnace transformer. The furnace transformer is often connected to the supply network via a medium-voltage transformer. The furnace transformer provides a plurality of voltage levels. For the range of constant power and other high-current ranges, the respective voltage level can be selected at the furnace transformer. Fine control within a certain voltage level can be carried out by means of impedance control, for example.

During this procedure, only a few voltage levels are possible and the electrode currents are subject to strong fluctuations. In order to reduce the fluctuations, the positionings of the electrodes are controlled mechanically, usually via hydraulic adjustment devices. The mechanical adjustment of the electrodes has a considerably lower dynamic response than the real behavior of the arcs. The fluctuations can therefore be compensated for only inadequately. Furthermore, the fluctuations result in considerable loads on the components, for example the high-current cables, the current-carrying supporting arms, the hydraulic cylinders etc. The fluctuations occur both in the melting phase and in a subsequent flat-bath phase.

When adjusting the electrode voltage via the voltage levels of the furnace transformer, the positioning of the electrodes must be continuously readjusted. The readjustment can be carried out, for example, in such a manner that there is control to a particular impedance or a particular power. However, since the dynamic response of the positioning device is relatively low in comparison with the changes in the electrical system of the arc, certain fluctuations remain and cannot be compensated for. As a result, the energy input into the molten metal is not optimal.

The prior art documents, in particular WO 2015/176 899 A1 and EP 3 124 903 A1 and, to a limited extent, also EP 1 026 921 A1, disclose procedures in which the electrode voltages can be adjusted continuously. These configurations provide considerable advantages over adjustment of the electrode voltage via voltage levels of the furnace transformer. On the one hand, the electrode voltages can be varied not only in stages, but rather continuously. On the other hand, the furnace transformer may have a simpler design because it does not have to provide a plurality of voltage levels. Furthermore, these configurations enable further types of control.

If—as known from the prior art—the electrode voltages can be adjusted continuously, electrical energy is often supplied with a constant power or a constant current. The power or the current may be at a maximum, that is to say as large as possible in design-related terms (“energy supply device, supply what you can”). The voltages applied to the electrodes are used in this case to adjust the desired power or the desired current. In particular during the starting phase of a melting phase of the electric arc furnace, when the electrodes are still rather far up in the vicinity of the cover of the electric arc furnace, this can result in the arc forming toward the cover, rather than toward the metal, as seen from the electrodes. This not only results in a considerably reduced input of energy into the metal, but also in considerably increased wear of the cover through to damage to the cover that occurs even after a short time.

The object of the present invention is to create possibilities by means of which the disadvantages of the prior art can be avoided.

The object is achieved by an operating method having the features of claim 1. Dependent claims 2 to 5 relate to advantageous configurations of the operating method.

According to the invention, an operating method of the type mentioned at the outset is configured by virtue of the fact that the control device, at least during a starting phase of the melting phase, determines the definitive target voltage values by limiting the preliminary target voltage values to a permissible maximum value, wherein the permissible maximum value is below a possible maximum value that can be applied to the electrodes by the energy supply device.

If, as seen from the design of the energy supply device, up to 1200 V can therefore be applied to the electrodes, for example, and 5000 A are intended to flow via the electrodes, the voltage is adjusted to the full 1200 V if necessary in the prior art in order to set the desired current of 5000 A. In contrast, according to the invention, such adjustment is carried out only to a value below 1200 V, for example to a maximum of 700 V. If a voltage value above 700 V is needed to set a current of 5000 A, the deviation of the current from the actual desired value (=5000 A) is accepted. As a result, although lower energy is supplied to the electric arc furnace, the supplied energy is reliably input to the metal that is intended to be melted, but not to components of the electric arc furnace itself. The numerical values of 700 V and 1200 V and 5000 A that are mentioned are values that are mentioned by way of example and are used for explanation. Higher or lower values may also occur in practice. In particular, the current may often be considerably greater.

In the very simplest configuration, the permissible maximum value is firmly predefined. In this case, it is possible for the permissible maximum value to be taken into account only during the starting phase of the melting phase, but to no longer be taken into account in a later section of the melting phase. Alternatively, it is possible for the permissible maximum value to be taken into account during the entire melting phase, but to no longer be taken into account in the subsequent flat-bath phase.

In other configurations, the permissible maximum value may be dynamic.

For example, it is possible for the control device to receive an input value from an operator and for the control device to determine the permissible maximum value on the basis of the input value. In this case, it is alternatively possible for the input value to always determine the permissible maximum value, that is to say for the permissible maximum value to always likewise be 500 V in the case of an input value of “500 V”, for example. Alternatively, it is possible for the input value to be predefined only in the sense of an upper limit. In this case, the control device can initially determine the permissible maximum value in another manner. If the value determined in this manner is less than the voltage value determined by the input value (for example only 450 V in comparison with 500 V according to the input value), the value determined by the control device (450 V) is used as the permissible maximum value. If the value determined by the control device is greater than the voltage value determined by the input value (for example 550 V), the voltage value determined by the input value (500 V) is used as the permissible maximum value. In this case too, the numerical values of 450 V, 500 V and 550 V that are mentioned are values that are mentioned purely by way of example and are used for explanation. Higher or lower values may also occur in practice.

A specification according to an input value can alternatively be made continuously or in stages.

In another configuration, it is possible for the control device—as an alternative or in addition to considering the input value—to determine the permissible maximum value on the basis of a period of time that has elapsed since the beginning of the melting phase. For example, the permissible maximum value may initially have a relatively low value and may be increased in a jump, in a plurality of stages or continuously (linearly or non-linearly) after the expiry of a particular waiting time of 5 minutes, for example. The permissible maximum value can be increased to the possible maximum value (and theoretically even above it) in later sections, that is to say after at least the starting phase of the melting phase. In this case, the voltage limitation according to the invention is no longer active after the time at which the possible maximum value is reached. The period of 5 minutes that is mentioned is only exemplary. Higher or lower values may also occur in practice.

As a general rule, a positioning of the electrodes varies over time. The positioning of the electrodes may be known to the control device. For example, the control device can also position the electrodes or the positioning of the electrodes can be supplied to the control device from the outside. In one configuration of the present invention, it is therefore possible for the control device to determine the permissible maximum value on the basis of the positioning of the electrodes.

In a similar manner to a determination on the basis of a period of time that has elapsed since the beginning of the melting phase, in the case of a determination on the basis of the positioning of the electrodes as well, the permissible maximum value may initially have a relatively low value and may be increased in a jump, in a plurality of stages or continuously (linearly or non-linearly) upon reaching certain positions, that is to say as a result in later sections of the melting phase. The permissible maximum value can be increased to the possible maximum value and even above it.

In another configuration of the present invention, it is possible for the control device to determine progress of the melting of the metal in the electric arc furnace by evaluating the temporal progression of second actual electrical variables of the electrical energy supplied to the electrodes and/or by evaluating actual acoustic variables of the electric arc furnace, and for the control device to determine the permissible maximum value on the basis of the determined progress.

The term “second actual electrical variables” is used for the purely formal distinction from the first actual electrical variables. It is intended to express that the actual electrical variables, on the basis of which the control device determines the progress of the melting of the metal in the electric arc furnace, are not necessarily the same actual electrical variables that are approximated, if possible, to the target electrical variables. Although this is possible, it is not absolutely necessary. For example, the first actual electrical variables may be the electrode currents, whereas the second actual electrical variables may be the voltages applied to the electrodes or the powers flowing via the electrodes. However, in the individual case, they may also be the same actual electrical variables.

In a similar manner to a determination on the basis of a period of time that has elapsed since the beginning of the melting phase, in the case of a determination on the basis of the determined progress as well, the permissible maximum value may initially have a relatively low value and may be increased in a jump, in a plurality of stages or continuously (linearly or non-linearly) upon reaching a certain amount of process progress. The permissible maximum value may be increased to the possible maximum value and even above it.

The object is furthermore achieved by a control program having the features of claim 6. According to the invention, the execution of the machine code by the control device has the effect that the control device operates the electric arc furnace in accordance with an operating method according to the invention.

The object is furthermore achieved by a control device having the features of claim 7. According to the invention, the control device is programmed with a control program according to the invention, such that the control device operates the electric arc furnace in accordance with an operating method according to the invention.

The object is furthermore achieved by an electric arc furnace having the features of claim 8. According to the invention, the control device is in the form of a control device according to the invention.

### BRIEF DESCRIPTION OF THE DRAWINGS

The above-described properties, features and advantages of the present invention and the manner in which they are achieved will become clearer and more easily understandable in connection with the following description of the exemplary embodiments, which are explained in more detail in association with the drawings, in which, in a schematic illustration:

FIG. 1 shows a block diagram of an electric arc furnace,

FIG. 2 shows a furnace vessel during a melting phase,

FIG. 3 shows a flowchart,

FIG. 4 shows the furnace vessel during a flat-bath phase,

FIG. 5 shows a timing diagram,

FIG. 6 shows a position diagram, and

FIG. 7 shows a phase diagram.

### DESCRIPTION OF THE EMBODIMENTS

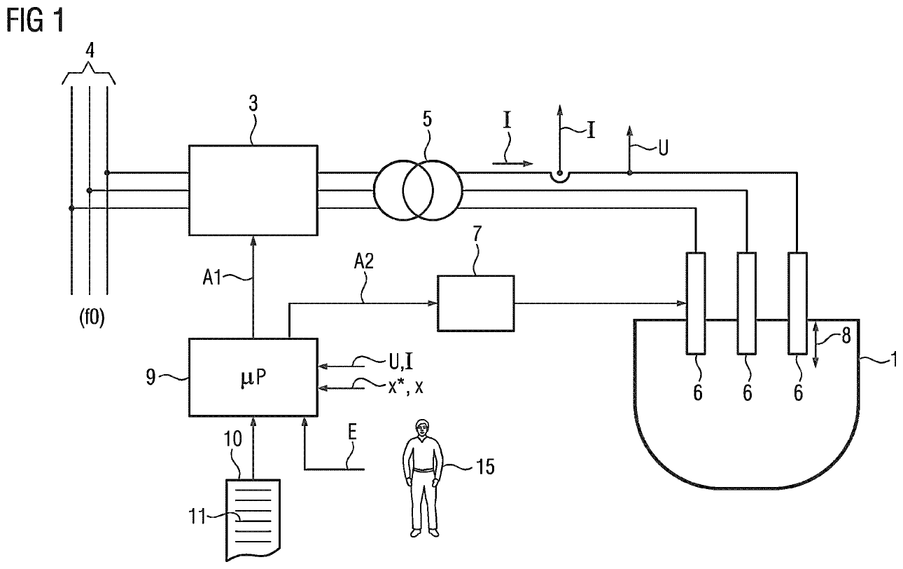

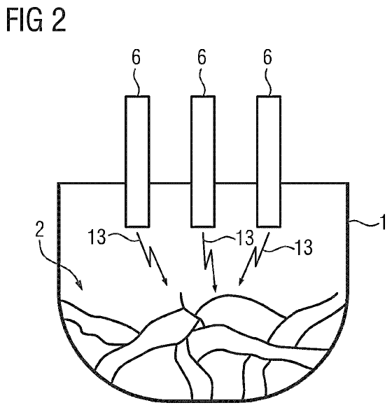

According to FIG. 1, an electric arc furnace has a furnace vessel 1. Metal 2 can be supplied to the furnace vessel 1—see FIG. 2. The metal 2 is supplied to the furnace vessel 1 in a solid state of matter. The metal 2 may be steel, for example, and may be in particular scrap metal in the case of steel.

The electric arc furnace also has an energy supply device 3. The energy supply device 3 is connected, on the input side, to a supply network 4. The supply network 4 is generally a medium-voltage network which has a nominal voltage in the 2-digit kV range and is operated at a base frequency f0. The base frequency f0 is generally 50 Hz or 60 Hz. According to the illustration in FIG. 1, the supply network 4 is generally a three-phase network.

The electric arc furnace also has a furnace transformer 5 and electrodes 6. The energy supply device 3 is connected, on the output side, to the electrodes 6 via the furnace transformer 5. According to the illustration in FIG. 1, a plurality of electrodes 6 are generally present and furthermore the furnace transformer 5 is in the form of a three-phase transformer. However, other configurations are also possible, in particular a single-phase configuration. However, irrespective of the specific configuration, electrode voltages U applied to the electrodes 6 are considerably below the nominal voltage of the supply network 4. The electrode voltage U is illustrated only for one of the electrodes 6 in FIG. 1. The electrode voltages U are usually in the range of several 100 V. In the individual case, voltages above 1 kV are also possible. However, 2 kV are generally not exceeded.

There are generally also switching devices which can be used to disconnect the energy supply device 3 from the supply network 4. There may also be switching devices which can be used to disconnect the energy supply device 3 from the furnace transformer 5 and/or to disconnect the furnace transformer 5 from the electrodes 6. The switching devices carry out purely binary switching operations, but no adjustment of voltages and currents. Furthermore, active or passive filter devices may be arranged on the primary side or secondary side of the furnace transformer 5. The switching devices and also the filter devices are of minor importance to the method of operation according to the invention and are therefore also not illustrated in FIG. 1 (and also in the other FIGS) for the sake of clarity.

The energy supply device 3 may draw electrical energy from the supply network 4 and may supply the electrical energy drawn to the electrodes 6 via the furnace transformer 5. For this purpose, the energy supply device 3 generally has a large number of semiconductor switches. Possible configurations of the energy supply device 3 are described in WO 2015/176 899 A1 (“gold standard”). Alternatively, the configurations according to EP 3 124 903 A1 or EP 1 026 921 A1 can also be used, for example. However, irrespective of the specific configuration of the energy supply device 3, the energy supply device 3 is able to carry out on the output side—that is to say toward the furnace transformer 5—a quasi-continuous graduation of the electrode voltages U applied to the electrodes 6 and/or of the electrode currents I supplied to the electrodes 6. In a similar manner to the illustration for the electrode voltages U, the electrode current I is likewise illustrated in FIG. 1 only for one of the electrodes 6.

The electrode voltages U may reach at most a value U0 (see FIGS. 5 to 7). The value U0—that is to say the possible maximum value of the electrode voltages U—is determined by the nominal voltage of the supply network 4, the design of the energy supply device 3 and the design of the furnace transformer 5. For example, the value U0 may be 1200 V.

Furthermore, the electric arc furnace has a positioning device 7. The positioning device 7 can be used to position the electrodes 6, as indicated in FIG. 1 by a double-headed arrow 8 beside one of the electrodes 6. In the simplest case, the electrodes 6 are positioned together. However, the electrodes 6 may also be positioned individually. The direction of movement in which the electrodes 6 are positioned may be vertical. Alternatively, the direction of movement may also be slightly inclined with respect to the vertical. In this case too, however, the component in the vertical direction is the dominant component of the movement. The positioning device 7 may have, for example, one or more hydraulic cylinder units.

Finally, the electric arc furnace has a control device 9. The control device 9 controls at least the energy supply device 3. The control device 9 therefore generates control values A1 that are used by the control device to control the energy supply device 3. The energy supply device 3 is operated according to the control values A1.

The positioning device 7 is often also controlled by the control device 9; in this case, the control device 9 generates further control values A2 which are used by the control device to control the positioning device 7. This case, the positioning device 7 is operated according to these control values A2. However, the control of the positioning device 7 as such is not the subject matter of the present invention and is therefore not explained in more detail.

The control device 9 is in the form of a software-programmable control device. This is indicated in FIG. 1 by the statement “μP” (for microprocessor-controlled). The mode of action and operation of the control device 9 is determined by a control program 10, with which the control device 9 is programmed. The control program 10 comprises machine code 11 that is executable by the control device 9. The execution of the machine code 11 by the control device 9 has the effect that the control device 9 operates the electric arc furnace in accordance with an operating method as explained in more detail below in conjunction with the further FIGS.

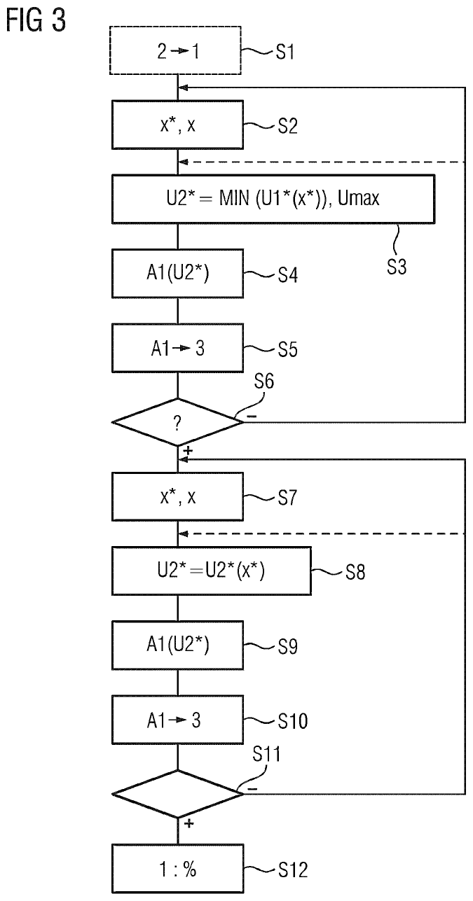

First of all, in a step S1, the furnace vessel 1 is loaded with the metal 2 according to FIG. 3. The loading can take place under the control of the control device 9. However, it need not take place under the control of the control device 9. Step S1 is therefore only illustrated using dashed lines in FIG. 3.

The loading of the furnace vessel 1 with the metal 2 is followed by a melting phase of the electric arc furnace. During the melting phase, the metal 2 is melted to form a molten metal 12. The melting phase comprises steps S2 to S6. The melting phase is followed by a flat-bath phase. The flat-bath phase comprises steps S7 to S11.

In the melting phase, the control device 9 first of all receives target variables X* in step S2. The target variables X* are electrical variables for electrical energy intended to be supplied to the electrodes 6. They may be, for example, target electrical currents or target electrical powers.

In step S3, the control device 9 determines definitive target voltage values U2*. In order to determine the definitive target voltage values U2*, the control device 9 first of all takes the target electrical variables X* (possibly with additional consideration of first actual electrical variables X which are characteristic of the electrical energy supplied to the electrodes 6) as a basis for determining preliminary target voltage values U1*. The preliminary target voltage values U1* are determined in such a manner that, when voltages U corresponding to the preliminary target voltage values U1* are applied to the electrodes 6, the first actual electrical variables X are approximated as far as possible to the corresponding target variables X*. An attempt is therefore made, for example, to approximate the actual electrical current or the actual electrical power as far as possible to the target electrical current or the target electrical power. However, the preliminary target voltage values U1* determined in this manner are upwardly limited to a permissible maximum value Umax in step S3. The permissible maximum value Umax is in turn (see FIGS. 5 to 7) below the possible maximum value U0. It is usually between 50% and 75% of the possible maximum value U0. In the case of a possible maximum value U0 of 1200 V, the permissible maximum value Umax may be between 600 V and 900 V, for example.

The control device 9 then determines the control values A1 for the energy supply device 3 in step S4. The determination is carried out on the basis of the definitive target voltage values U2*. In step S5, the control device 9 controls the energy supply device 3 according to the determined control values A1. On account of the corresponding control, voltages U corresponding to the definitive target voltage values U2* are applied to the electrodes 6. As a result, the energy supply device 3 draws electrical energy from the supply network 4 and supplies the electrical energy to the electrodes 6 via the furnace transformer 5. Arcs 13 are formed as a result.

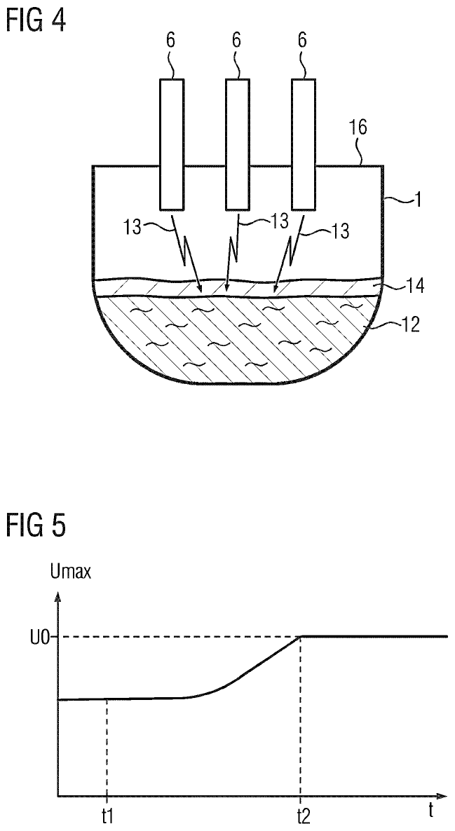

In step S6, the control device 9 checks whether a completion condition has been reached. The completion condition may be that the melting phase as such has ended. The melting phase has ended when the molten metal 12 has completely or at least substantially formed a continuous horizontal surface according to the illustration in FIG. 4. Therefore, either the metal 2 has completely melted or the as yet unmelted elements of the metal 2 are completely below the surface of the molten metal 12 or the as yet unmelted elements of the metal 2 project only insignificantly beyond the surface of the molten metal 12. Furthermore, a slag layer 14 may have formed on the surface of the molten metal 12. Alternatively, the completion condition may be, for example, that a starting phase, for example a boring phase, has been completed within the melting phase. However, irrespective of the configuration of the completion condition, the completion condition is generally complied with only for several minutes after the beginning of the melting phase.

It is possible for the control device 9 to evaluate metrologically captured actual variables of the electric arc furnace as part of checking whether the completion condition has been reached. For example, it is possible for the control device 9 to evaluate the electrode currents I and/or the electrode voltages U, in particular their fluctuations. The control device 9 may also evaluate acoustic variables of the electric arc furnace, for example the noise level or the acoustic spectrum of the noise generated. Alternatively, it is possible for an operator 15 (see FIG. 1) to specify to the control device 9 that the completion condition has been reached.

If the completion condition has not yet been reached, the control device 9 returns to step S2 (alternatively to step S3). In contrast, if the completion condition has been reached, the control device 9 changes to step S7 and therefore to a further operating phase of the electric arc furnace. The further operating phase may be the flat-bath phase, for example. Alternatively, the further operating phase may be a later section of the melting phase plus the flat-bath phase.

In the further operating phase of the electric arc furnace, the control device 9 receives the target variables X* in step S7. Furthermore, the control device 9 determines the definitive target voltage values U2* in step S8. The control device 9 then determines the control values A1 for the energy supply device 3 in step S9. In step S10, the control device 9 controls the energy supply device 3 according to the determined control values A1.

Steps S7 to S10 correspond substantially to steps S2 to S5. The difference is only that the control device 9 directly accepts the preliminary target voltage values U1* as definitive target voltage values U2* in step S8, that is to say does not carry out any limitation to the permissible maximum value Umax.

In step S11, the control device 9 checks whether the further operating phase of the electric arc furnace has ended. In a similar manner to the check in step S6, it is possible for the control device 9 to evaluate metrologically captured actual variables of the electric arc furnace as part of the check in step S11. Alternatively, it is possible for the operator 15 to specify to the control device 9 that the further operating phase has ended.

If the further operating phase has not yet ended, the control device 9 returns to step S7 (alternatively to step S8). In contrast, if the further operating phase has ended, the control device 9 changes to a step S12. In step S12, the molten metal 12 produced is removed from the furnace vessel 1, for example poured into a pan (not illustrated). The molten metal 12 can be removed under the control of the control device 9. However, it need not take place under the control of the control device 9. Therefore, step S12 is only illustrated using dashed lines in FIG. 3—in a similar manner to step S1.

It is also possible for steps S6 to S10 to be dispensed with and instead to return from step S11 to step S2 or step S3. In this case, the permissible maximum value Umax is taken into account during the entire operation of the electric arc furnace.

There are various possibilities for determining the permissible maximum value Umax.

For example, the permissible maximum value Umax may be determined by the control device 9 as a function of the time t according to the illustration in FIG. 5. In this case, a time t1 corresponds to the beginning of the melting phase, that is to say, in principle, the first time the arcs 13 are ignited after the furnace vessel 1 has been loaded with the metal 2. The permissible maximum value Umax generally has its lowest value at the time t1. The permissible maximum value Umax may increase later to a higher value—continuously according to the illustration in FIG. 5 or alternatively in one or more stages. In particular, it can reach the possible maximum value U0 at a time t2. In the case of the configuration according to FIG. 5, the control device 9 therefore determines the permissible maximum value Umax in a manner directly dependent on a period of time that has elapsed since the beginning of the melting phase: If the period of time that has elapsed since the beginning of the melting phase is known, the associated instantaneously valid permissible maximum value Umax can also be determined.

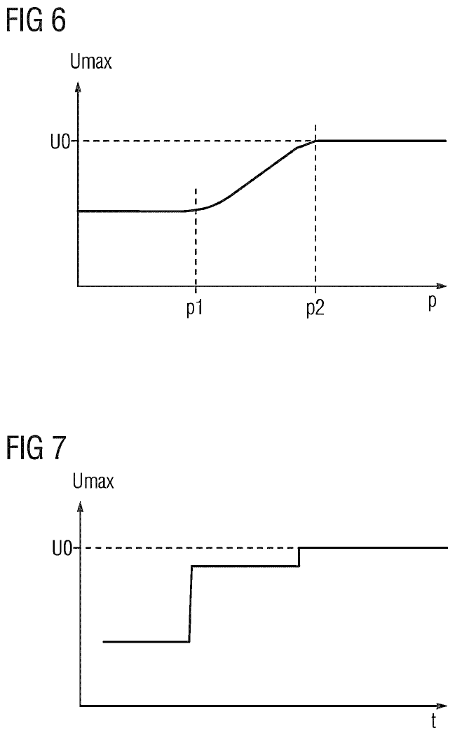

Alternatively, the permissible maximum value Umax may be determined by the control device 9 as a function of the positioning p of the electrodes 6 according to the illustration in FIG. 6. The illustration in FIG. 6 is such that the positioning p corresponds to the distance between the undersides of the electrodes 6 and a cover 15 of the furnace vessel 1. The permissible maximum value Umax generally has its lowest value at the smallest positioning p (that is to say at the shortest distance from the cover 15) and increases with increasing distance to a higher value—continuously according to the illustration in FIG. 6 or alternatively in one or more stages. In particular, the permissible maximum value Umax may be at its lowest value up to a first predetermined positioning p and may reach the possible maximum value U0 at a second predetermined positioning p. In the case of the configuration according to FIG. 6, the control device 9 therefore determines the permissible maximum value Umax on the basis of the positioning p of the electrodes 6.

In the case of the configuration according to FIG. 6, the permissible maximum value Umax is also naturally as a result dependent on the time t. However, the associated functional relationship is not known in advance. In particular, the situation may arise in which the positioning p does not increase continuously, but rather also temporarily assumes a lower value again.

It is likewise possible for the control device 9 (in a similar manner to the procedure in steps S6 and S11) to determine progress of the melting of the metal 2 in the electric arc furnace by evaluating the temporal progression of actual electrical variables of the electrical energy supplied to the electrodes 6 and/or by evaluating actual acoustic variables of the electric arc furnace. For example, the control device 9 may detect in this manner the transition from the boring phase to the remaining part of the melting phase and the transition from the melting phase to the flat-bath phase. In this case, the control device 9 can determine the permissible maximum value Umax on the basis of the determined progress. For example, the control device 9 may keep the permissible maximum value Umax at a relatively low value during the boring phase according to the illustration in FIG. 7, can keep it at a relatively high value (but still below the possible maximum value U0) during the remaining part of the melting phase and can disregard it during the flat-bath phase (or alternatively can set it equal to the possible maximum value U0 or to a value above the possible maximum value U0).

According to the illustration in FIG. 1, it is likewise possible for the control device 9 to receive an input value E from the operator 15. In this case, the control device 9 can determine the permissible maximum value Umax on the basis of the input value E. The input value E may alone determine the permissible maximum value Umax if necessary or may be taken into account in addition to one of the procedures in FIGS. 5 to 7.

The present invention has many advantages. In particular, flashovers of the arcs 13 to the cover 16 of the furnace vessel 1 and the associated disadvantages can be reliably avoided.

Although the invention has been more specifically illustrated and described in detail by way of the preferred exemplary embodiment, nevertheless the invention is not restricted by the examples disclosed and other variants can be derived therefrom by a person skilled in the art without departing from the scope of protection of the invention.

### LIST OF REFERENCE SIGNS

1 Furnace vessel
2 Metal
3 Energy supply device
4 Supply network
5 Furnace transformer
6 Electrodes
7 Positioning device
8 Double-headed arrow
9 Control device
10 Control program
11 Machine code
12 Molten metal
13 Arcs
14 Slag layer
15 Operator
16 Cover
A1, A2 Control values
E Input value
f0 Base frequency
I Electrode currents
p Positioning
p1, p2 Predetermined positionings
S1 to S12 Steps
t Time
t1, t2 Times
U Electrode voltages
U0 Possible maximum value
Umax Permissible maximum value
Target variables X*
Actual variables X

1. An operating method for an electric arc furnace, wherein metal in a furnace vessel of the electric arc furnace is melted during a melting phase, wherein a control device of the electric arc furnace,
determines preliminary target voltage values (U1*) on the basis of target electrical variables (X*) of electrical energy to be supplied to the electrodes, with the result that, when voltages (U) corresponding to the preliminary target voltage values (U1*) are applied to the electrodes, first actual electrical variables (X) of electrical energy supplied to the electrodes are approximated as far as possible to the target electrical variables (X*), and
controls an energy supply device of the electric arc furnace on the basis of definitive target voltage values (U2*), with the result that voltages (U) corresponding to the definitive target voltage values (U2*) are applied to the electrodes, with the result that the energy supply device draws electrical energy from a supply network and supplies it to the electrodes via a furnace transformer (5), wherein the control device, at least during a starting phase of the melting phase, determines the definitive target voltage values (U2*) by limiting the preliminary target voltage values (U1*) to a permissible maximum value (Umax), wherein the permissible maximum value (Umax) is below a possible maximum value (U0) that can be applied to the electrodes by the energy supply.

2. The operating method as claimed in claim 1, wherein the control device receives an input value (E) from an operator, and in that the control device determines the permissible maximum value (Umax) on the basis of the in-put value (E).

3. The operating method as claimed in claim 1, wherein the control device determines the permissible maximum value (Umax) on the basis of a period of time that has elapsed since the beginning of the melting phase.

4. The operating method as claimed in claim 1, wherein a positioning (p) of the electrodes varies over time, in that the positioning (p) of the electrodes is known to the control device, and in that the control device determines the permissible maximum value (Umax) on the basis of the positioning (p) of the electrodes.

5. The operating method as claimed in claim 1, wherein the control device determines progress of the melting of the metal in the electric arc furnace by evaluating the temporal progression of second actual electrical variables (U, I) of the electrical energy supplied to the electrodes and/or by evaluating actual acoustic variables of the electric arc furnace, and in that the control device determines the permissible maximum value (Umax) on the basis of the determined progress.

6. A control program product for a control device of an electric arc furnace comprising a non-transitory computer-readable storage device and a control program stored on the non-transitory computer-readable storage device, wherein the control program comprises machine code which can be executed by the control device, wherein the execution of the machine code by the control device has the effect that the control device operates the electric arc furnace in accordance with the operating method as claimed in claim 1.

7. A control device of an electric arc furnace, wherein the control device comprises a non-transitory computer-readable device storing a control program, such that the control device operates the electric arc furnace in accordance with the operating method as claimed in claim 1.

8. An electric arc furnace,
wherein the electric arc furnace has a furnace vessel, to which metal can be supplied,
wherein the electric arc furnace has an energy supply device and electrodes as well as a furnace transformer,
wherein the energy supply device is connected, on the input side, to a supply network (4) and is connected, on the output side, to the electrodes via the furnace transformer,
wherein the electric arc furnace has a control device which can control the energy supply device,
wherein the control device is designed as claimed in claim 7.
